(19) United States
(12) Patent Application Publication
(10) Pub. No.: US 2026/0104858 A1
(43) Pub. Date: Apr. 16, 2026

(54) ARITHMETIC PROCESSING APPARATUS, PROCESSOR, AND COMPUTER-IMPLEMENTED ARITHMETIC METHOD

(71) Applicant: Fujitsu Limited, Kawasaki-shi (JP)

(72) Inventor: Yuhei Takata, Kawasaki (JP)

(73) Assignee: Fujitsu Limited, Kawasaki-shi (JP)

(21) Appl. No.: 19/358,186

(22) Filed: Oct. 14, 2025

(30) Foreign Application Priority Data
Oct. 15, 2024 (JP) 2024-179802

(51) Int. Cl. G06F 7/544; G06F 7/483

(52) U.S. Cl. CPC G06F 7/5443; G06F 7/483

(57) ABSTRACT

An arithmetic processing apparatus including a memory configured to store a first floating-point multiply-add operation instruction and a second floating-point multiply-add operation instruction, the first floating-point multiply-add operation instruction and the second floating-point multiply-add operation instruction being data-dependent, and a processor configured to execute the first floating-point multiply-add operation instruction and the second floating-point multiply-add operation instruction which are read from the memory, the processor being configured to bypass a value before rounding and a signal indicating whether or not an increment has occurred in the rounding, to be input to the processor, and execute the second floating-point multiply-add operation instruction using the input to the processor before an execution of the first floating-point multiply-add operation instruction is completed.

### CROSS-REFERENCE TO RELATED APPLICATION

This application is based upon and claims the benefit of priority of the prior Japanese Patent application No. 2024-179802, filed on October 15, 2024, the entire contents of which are incorporated herein by reference.

### FIELD

The present disclosure relates to an arithmetic processing apparatus, a processor, and a computer-implemented arithmetic method.

### BACKGROUND

Floating-point multiply-add arithmetic operations (FMA operations) having data dependency are used in inner product arithmetic operations frequently calculated in AI processing, typified by dgemm that is also used as an index to measure floating-point calculation performance of processors. In recent years, a method for rapidly performing data-dependent FMA operations has become important.

A floating-point multiply-add operation is an arithmetic operation that simultaneously performs a floating-point multiplication and a floating-point addition, expressed by the formula A*B + C.

Here, “data dependency” refers a situation where the result of a preceding FMA operation is input as the addend (C) of a subsequent FMA operation.

In general, a floating-point multiply-add arithmetic unit (FMA arithmetic unit) is used as the arithmetic unit that performs FMA operations.

When data-dependent FMA operations are executed, the execution of a subsequent FMA operation is delayed until the preceding FMA operation is completed. Such an execution is referred to as a sequential execution.

FIG. 1 is a diagram illustrating a floating-point number.

For floating-point numbers, standardized formats are defined in IEEE 754-2008. A floating-point number has a sign part S (see the symbol A1), an exponent part E (see the symbol A2), and a significand part F (see the symbol A3), and is represented as illustrated in FIG. 1.

A normalized number is expressed as (-1)S*2E-bias*1.F, and a denormalized number is expressed as (-1)S*2E-bias+1*0.F.

For example, a related art is disclosed in Japanese Patent Application Publication No. H9-212482.

### SUMMARY

According to an aspect of the embodiment, an arithmetic processing apparatus including a memory configured to store a first floating-point multiply-add operation instruction and a second floating-point multiply-add operation instruction, the first floating-point multiply-add operation instruction and the second floating-point multiply-add operation instruction being data-dependent, and a processor configured to execute the first floating-point multiply-add operation instruction and the second floating-point multiply-add operation instruction which are read from the memory, the processor being configured to bypass a value before rounding and a signal indicating whether or not an increment has occurred in the rounding, to be input to the processor, and execute the second floating-point multiply-add operation instruction using the input to the processor before an execution of the first floating-point multiply-add operation instruction is completed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a floating-point number;

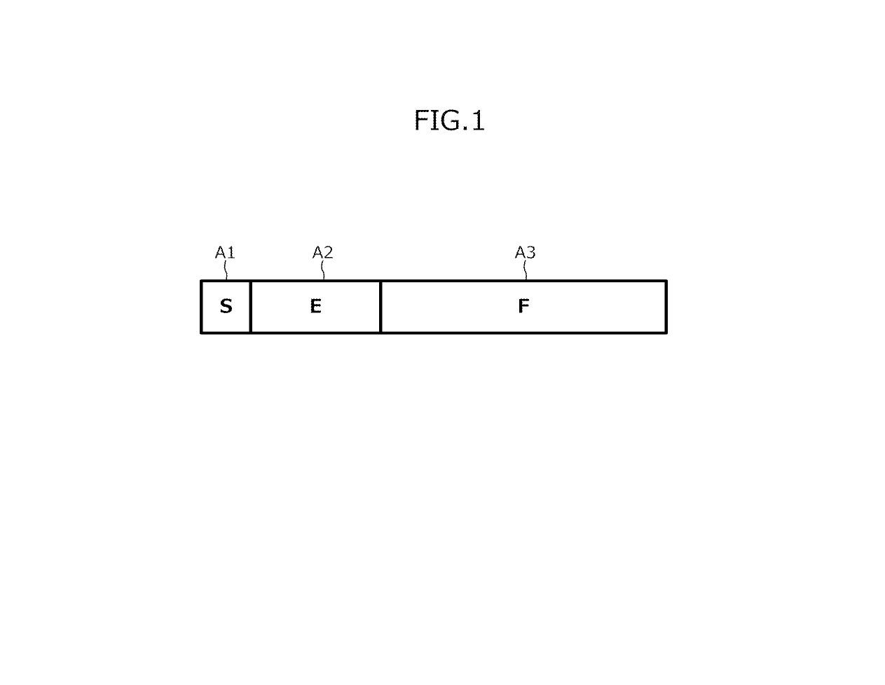

FIG. 2 is a block diagram schematically illustrating an example of the configuration of an FMA arithmetic unit in a related example;

FIG. 3 is a table exemplifying instruction execution cycles in the FMA arithmetic unit illustrated in FIG. 2;

FIG. 4 is a block diagram schematically illustrating an example of the configuration of an FMA arithmetic unit in an embodiment;

FIG. 5 is a table exemplifying instruction execution cycles in the FMA arithmetic unit illustrated in FIG. 4;

FIG. 6 is a diagram illustrating a calculation example in a Carry Save Adder (CSA) TREE and a COMPRESSOR illustrated in FIG. 4;

FIG. 7 is a diagram illustrating an addition process performed by the CSA TREE and the COMPRESSOR illustrated in FIG. 4;

FIG. 8 is a diagram illustrating the change of the alignment shift amount;

FIG. 9 is a flowchart illustrating FMA operation processing in the embodiment;

FIG. 10 is a block diagram schematically illustrating an example of the hardware configuration of an arithmetic processing apparatus that executes the FMA arithmetic unit in the embodiment;

FIG. 11 is a table exemplifying instruction execution cycles in a case where the processing from inputs A and B completes in four cycles and the processing from an input C completes in two cycles;

FIG. 12 is a table exemplifying instruction execution cycles in a case where the latencies of all inputs are four cycles; and

FIG. 13 is a table exemplifying instruction execution cycles in a case where only the bypass of FMA operations is performed one cycle earlier.

### DESCRIPTION OF EMBODIMENT(S)

As described above, when sequential execution is performed, the execution of a subsequent FMA operation is delayed until the preceding FMA operation is completed. In this case, if one FMA operation takes five cycles, executing n continuous data-dependent FMA operations requires 5n cycles. Hence, data-dependent FMA operations may not be able to be processed at a high speed.

### Related Example

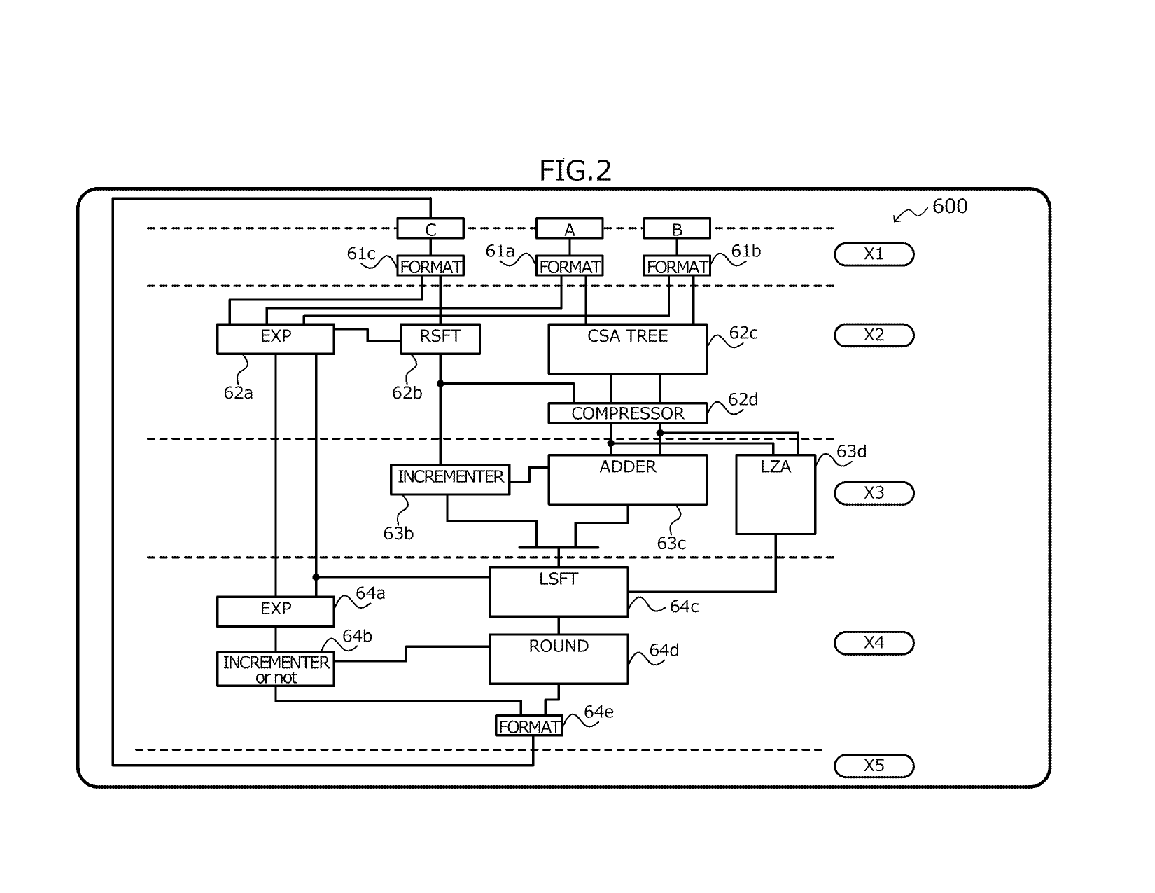

FIG. 2 is a block diagram schematically illustrating an example of the configuration of an FMA arithmetic unit 600 in a related example.

The FMA arithmetic unit 600 illustrated in FIG. 2 executes FMA instructions in five cycles from X1 to X5.

The FMA arithmetic unit 600 includes FORMATs 61a to 61c for executing processing in the cycle X1, and includes an Exponential (EXP) 62a, a Right Shift (RSFT) 62b, a CSA TREE 62c, and a COMPRESSOR 62d for executing processing in the cycle X2. The FMA arithmetic unit 600 further includes an INCREMENTER 63b, an ADDER 63c, and a Leading Zero Analyzer (LZA) 63d for executing processing in the cycle X3. Furthermore, the FMA arithmetic unit 600 includes an EXP 64a, an INCREMENTER or not 64b, a Left Shift (LSFT) 64c, a ROUND 64d, and a FORMAT 64e for executing processing in the cycle X4.

In the cycle X1, each of input data A, B, and C, which are the operands, is divided into the sign part, the exponent part, and the significand part by the FORMATs 61a to 61c, respectively.

In the cycle X2, the CSA TREE 62c multiplies the significands of A and B, which are multiplication operands, and outputs the result as SUM/CRY in the carry-save format. On the other hand, the significand of the addend operand C is right-shifted in the RSFT 62b according to the exponent difference between A*B and C. This right shift is generally called alignment.

The lower part of the significand of C aligned with the result from the CSA TREE 62c is converted into two SUM/CRYs in the carry-save format from the three inputs in the COMPRESSOR 62d. On the other hand, the upper part of the significand of the aligned C is input to the INCREMENTER 63b.

The EXP 62a calculates the shift amount for alignment based on the respective exponents of the input data A, B, and C. Specifically, the EXP 62a performs subtraction between the exponent of A*B and the exponent of C to calculate the shift amount. In addition, through the line connected from the EXP 62a to the LSFT 64c, the shift amount calculated by the EXP 62a is input as the shift amount for normalization when the exponent of C is greater than that of A*B.

The EXP 62a also determines the intermediate value of the exponent part of the calculation result. The determination of the intermediate value by the EXP 62a is similar to the selection between the INCREMENTER 63b and the ADDER 63c, and the exponent of A*B is compared with the exponent of C and a sufficiently greater one is selected as the intermediate value.

In the cycle X3, the ADDER 63c adds the SUM/CRYs in the carry-save format output from the COMPRESSOR 62d.

The INCREMENTER 63b determines whether or not to increment the upper part of the aligned addend C by +1, depending on whether or not a carry-out has occurred in the result from the ADDER 63c, and outputs the result.

The LZA 63d is a circuit that predicts the number of leading zeros in the result of the addition from the ADDER 63c.

The input to the LSFT 64c is selected from the results of the INCREMENTER 63b and the ADDER 63c. This selection is determined by the difference between the exponent of the input C and the exponent of the result of the multiplication A*B. For example, if the exponent of C is sufficiently larger than that of A*B, only the result from the INCREMENTER 63b is selected, whereas if the exponent of C is equivalent to or less than that of A*B, the result from the ADDER 63c is always selected.

In the cycle X4, the LSFT 64c left-shifts the above selected result according to the exponent difference and the result from the LZA 63d. This left shift is generally called normalization. This is because the normalized value of a floating-point number has a leading 1 in the integer bit. Therefore, when the upper bits of the selected result contain zeros, a left shift is required.

The ROUND 64d performs rounding on the result from the LSFT 64c. The rounding is performed depending on whether or not an increment by +1 is to be performed.

The FORMAT 64e outputs the sign part, the exponent part, and the significand part collectively into a standardized format.

The EXP 64a is a circuit that performs processing to reflect the amount of left shift due to normalization to the exponent. For example, assuming that the exponent of A*B is selected as the intermediate value by the EXP 62a, and digit loss occurs in the ADDER 63c, so that leading 0s appear, the exponent value needs to be decreased by the amount of normalization. The EXP 64a performs the processing to subtract the normalization amount from this intermediate value. On the other hand, when the INCREMENTER 63b is selected, the exponent of C is selected as the intermediate value, and when a right-shift alignment has been performed, the EXP 64a may perform a left shift by the same amount for normalization.

The INCREMENTER or not 64b is a circuit that performs correction of the exponent when the value of the significand part exceeds 2 due to the rounding.

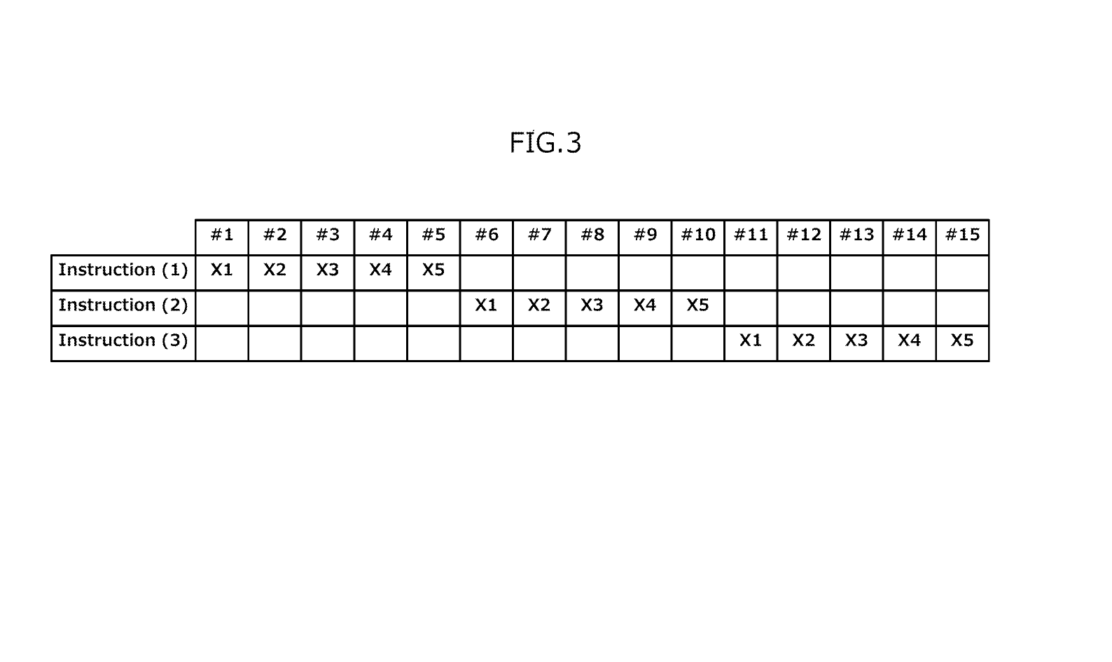

FIG. 3 is a table illustrating instruction execution cycles in the FMA arithmetic unit 600 illustrated in FIG. 2.

As illustrated in FIG. 3, in each of FMA instructions (1) to (3) that have successive data dependencies, processing of the cycles X1 to X5 is executed. The processing in the cycles X1 to X5 of the instruction (1) is executed at time #1 to #5; the processing of the cycles X1 to X5 of the instruction (2) is executed at time #6 to #10; and the processing of the cycles X1 to X5 of the instruction (3) is executed at time #11 to #15.

### Embodiment

Hereinafter, an embodiment will be described with reference to the drawings. However, the embodiment described below is merely exemplary, and it is not intended to exclude various modifications or applications of techniques not explicitly described in the embodiment. In other words, the present embodiment may be embodied in various modifications without departing from the spirit thereof. In addition, each drawing does not imply that only the constituting elements illustrated in the drawing are provided, but other constituting elements or the like may also be included.

### Example of Software Configuration

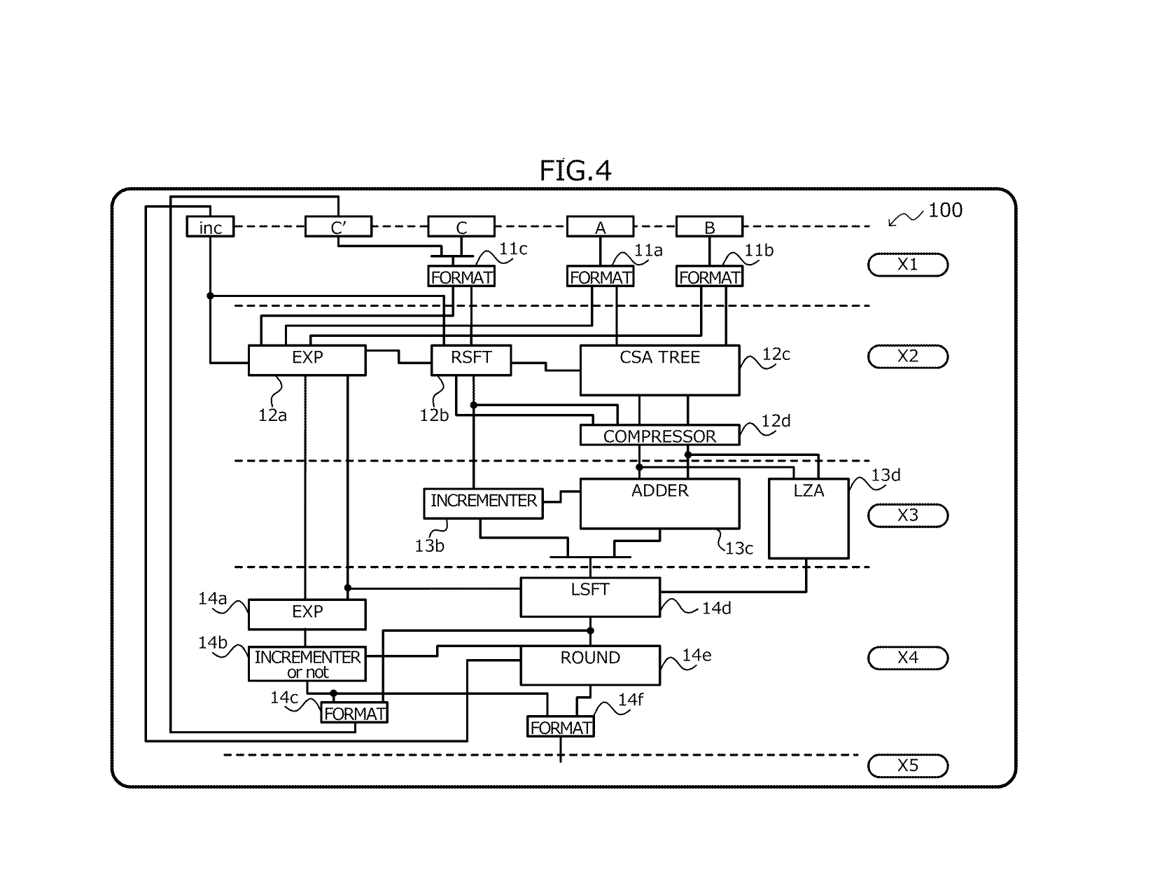

FIG. 4 is a block diagram schematically illustrating an example of the configuration of an FMA arithmetic unit 100 in the embodiment.

The FMA arithmetic unit 100 illustrated in FIG. 4 executes FMA instructions in five cycles from X1 to X5.

The FMA arithmetic unit 100 includes FORMATs 11a to 11c for executing processing in the cycle X1, and includes an EXP 12a, an RSFT 12b, a CSA TREE 12c, and a COMPRESSOR 12d for executing processing in the cycle X2. The FMA arithmetic unit 100 further includes an INCREMENTER 13b, an ADDER 13c, and an LZA 13d for executing processing in the cycle X3. Furthermore, the FMA arithmetic unit 100 includes an EXP 14a, an INCREMENTER or not 14b, a FORMAT 14c, an LSFT 14d, a ROUND 14e, and a FORMAT 14f for executing processing in the cycle X4.

In the cycle X1, each of input data A, B, and C, which are the operands, is separated into a sign part, an exponent part, and a significand part by the FORMATs 11a to 11c, respectively.

In the cycle X2, the CSA TREE 12c multiplies the significands of A and B, which are multiplication operands, and outputs the result as SUM/CRY in the carry-save format. On the other hand, the significand of the addend operand C is right-shifted in the RSFT 12b according to the exponent difference between A*B and C. This right shift is generally called alignment.

The lower part of the significand of C aligned with the result from the CSA TREE 12c is converted into two SUM/CRYs in the carry-save format from the three inputs in the COMPRESSOR 12d. On the other hand, the upper part of the significand of the aligned C is input to the INCREMENTER 13b. It should be noted that the RSFT 12b and the COMPRESSOR 12d are connected not only by the signal line for inputting signal from the FORMAT 11c, but also by the signal line for inputting the signal inc.

The EXP 12a calculates the shift amount for alignment based on the respective exponents of the input data A, B, and C. Specifically, the EXP 12a performs subtraction between the exponent of A*B and the exponent of C to calculate the shift amount. In addition, through the line connecting from the EXP 12a to the LSFT 14d, the shift amount calculated by the EXP 12a is input as the shift amount for normalization when the exponent of C is greater than that of A*B.

For example, if the exponent of A*B and the exponent of C are the same, the alignment is performed just enough to align the integer bits of C and A*B. Assuming that IEEE single-precision floating points are used, the significand part is 23 bits. Therefore, if the exponent of C is equal to the exponent of A*B, the shift will be a 24 bit shift including the integer bit. Based on this amount, if the exponent of C is larger, the shift amount is reduced, whereas if the exponent of A*B is larger, the shift amount is increased.

Alternatively, the shift amount may be set in anticipation that the result of the multiplication of the significands of A*B exceeds 2. For example, since the width of the ADDER 13c may be extended by 1 bit, or since an additional 1 bit may be allocated to the INCREMENTER 13b to preserve a guard bit as rounding information, the shift amount may be designed to be 26 bits if the exponents are the same.

If the exponent of C is somewhat greater than the exponent of A*B, the output from the ADDER 13c and the output from the INCREMENTER 13b are not selected exclusively. In such a case, the upper part of the significand part of C aligned to an extent where the integer bits do not align remains in part in the INCREMENTER 13b, the remaining part of the significand part of C and the significand part of the result of the multiplication of A*B are added, and the result of this addition output from the ADDER 13c is concatenated. At this time, in normalization shifting, a left shift by the same amount as the alignment is performed, and the result of the INCREMENTER 13b is left-aligned. At that time, the value shifted in is used as the upper bits of the output from the ADDER 13c.

The EXP 12a also determines the intermediate value of the exponent part of the calculation result. The determination of the intermediate value by the EXP 12a is similar to the selection between the INCREMENTER 13b and the ADDER 13c, and the exponent of A*B is compared with the exponent of C and a sufficiently greater one is selected as the intermediate value.

In the cycle X3, the ADDER 13c adds the SUM/CRYs in the carry-save format output from the COMPRESSOR 12d.

The INCREMENTER 13b determines whether or not to increment the upper part of the aligned significand C by +1, depending on whether or not a carry-out has occurred in the result from the ADDER 13c. Then, if it is determined to increment by +1, the INCREMENTER 13b outputs the value obtained by incrementing by +1 to the upper part of the aligned significand C, and if not, the INCREMENTER 13b outputs the upper part of the aligned significand C as is.

The LZA 13d is a circuit that predicts the number of leading zeros in the result of the addition by the ADDER 13c.

The input to the LSFT 14d is selected from the results of the INCREMENTER 13b and the ADDER 13c. This selection is determined by the difference between the exponent of the input C and the exponent of the result of the multiplication A*B. For example, if the exponent of C is sufficiently larger than that of the result of the multiplication A*B (e.g., equal to or greater than a given threshold), only the INCREMENTER 13b is selected, whereas if the exponent of C is equivalent to or less than that of A*B, the result from the ADDER 13c is always selected.

In the cycle X4, the LSFT 14d left-shifts the above selected result according to the exponent difference and the result from the LZA 13d. This left shift is generally called normalization. This is because the normalized value of a floating-point number has a leading 1 in the integer bit. Therefore, when the upper bits of the selected result contain zeros, a left shift is required.

The ROUND 14e performs rounding on the result from the LSFT 14d. The rounding is performed depending on the determination result as to whether or not to an increment by +1 is to be performed by the INCREMENTER 13b.

The FORMAT 14f outputs the sign part, the exponent part, and the significand part collectively into a standardized format.

The EXP 14a is a circuit that performs processing to reflect the amount of left shift due to normalization to the exponent. For example, assuming that the exponent of A*B is selected as the intermediate value by the EXP 12a, and digit loss occurs in the ADDER 13c, so that leading 0s appear, the exponent value needs to be decreased by the amount of normalization. The EXP 14a performs the processing to subtract the normalization amount from this intermediate value. On the other hand, when the INCREMENTER 13b is selected, the exponent of C is selected as the intermediate value, and when a right-shift alignment has been performed, the EXP 14a may perform a left shift by the same amount for normalization.

The INCREMENTER or not 14b is a circuit that performs correction of the exponent when the value of the significand part exceeds 2 due to the rounding.

In the embodiment, in order to allow the execution of a subsequent FMA instruction without waiting for the completion of a preceding FMA instruction, data C’ that has skipped the rounding increment in the ROUND 14e is bypassed.

At this time, the FORMAT 14c generates and bypasses C’ by combining the significand part data that has skipped the rounding increment, and the sign part and the exponent collectively into the standardized format.

In addition, the signal inc, which is a signal indicating whether or not an increment due to rounding has occurred, is bypassed along with the unrounded result C’.

The subsequent instruction handles the exponent part and the significand part in a manner similar to the normal input C, but the rounding increment (+1) that has not been performed in the preceding instruction needs to be performed. Here, the correction is made based on the information of the above-mentioned signal inc, which indicates whether or not an increment has occurred. If +1 is simply performed to the significand of the input C as is as the correction method, the delay would be increased and the latency of the FMA operation would be extended.

Therefore, in order to reduce the impact of the delay, the information of +1 is converted into data with a width of the significand (called a mask) in the RSFT 12b, which is added by either the CSA TREE 12c or the COMPRESSOR 12d (in other words, the carry-save adder) that perform A*B+C of the significand parts.

The number of stages in the CSA varies depending on the data size being handled; generally, a 3-input CSA compresses partial products from three rows to two rows, while a 5-input CSA compresses partial products from four rows to two rows. If there is a remainder in the number of partial products, correction can be performed without affecting the delay.

It should be noted that, as an example, the generation of the mask is performed in the RSFT 12b because the mask can be generated from the signal inc and the shift amount for alignment, but a separate block for generating the mask may be provided.

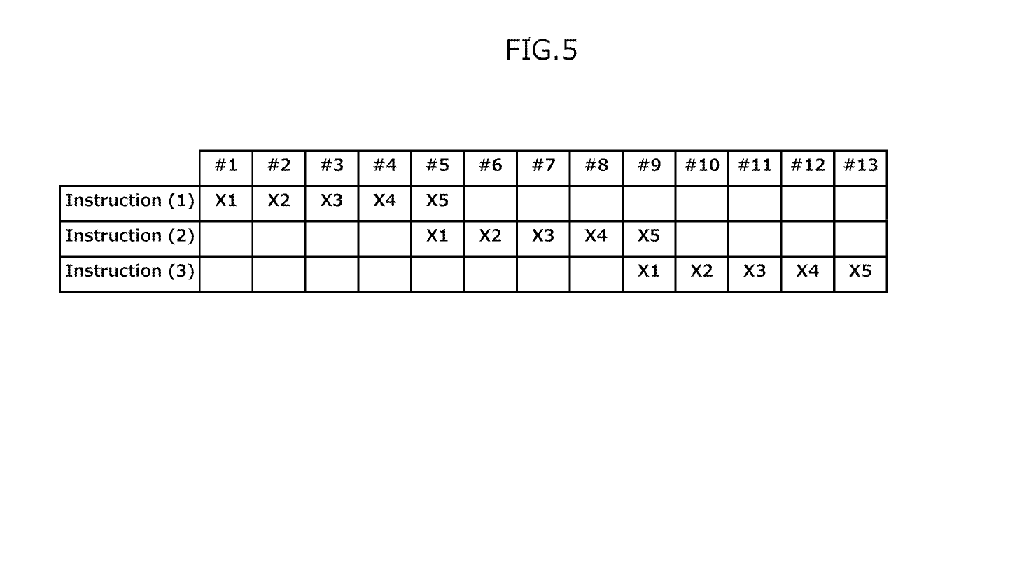

FIG. 5 is a table illustrating instruction execution cycles in the FMA arithmetic unit 100 illustrated in FIG. 4.

As illustrated in FIG. 5, in each of FMA instructions (1) to (3) that have successive data dependencies, processing of the cycles X1 to X5 is executed. The processing in the cycles X1 to X5 of the instruction (1) is executed at time #1 to #5; the processing of the cycles X1 to X5 of the instruction (2) is executed at time #5 to #9; and the processing of the cycles X1 to X5 of the instruction (3) is executed at time #9 to #13.

Thus, in the example illustrated in FIG. 5, the cycle X5 of the instruction (1) and the cycle X1 of the instruction (2) are executed simultaneously at time #5, and the cycle X5 of the instruction (2) and the cycle X1 of the instruction (3) are executed simultaneously at time #9. As a result, the subsequent FMA instruction can be started without waiting for the completion of the preceding FMA instruction, and two units of time can be reduced compared to the related example illustrated in FIG. 3.

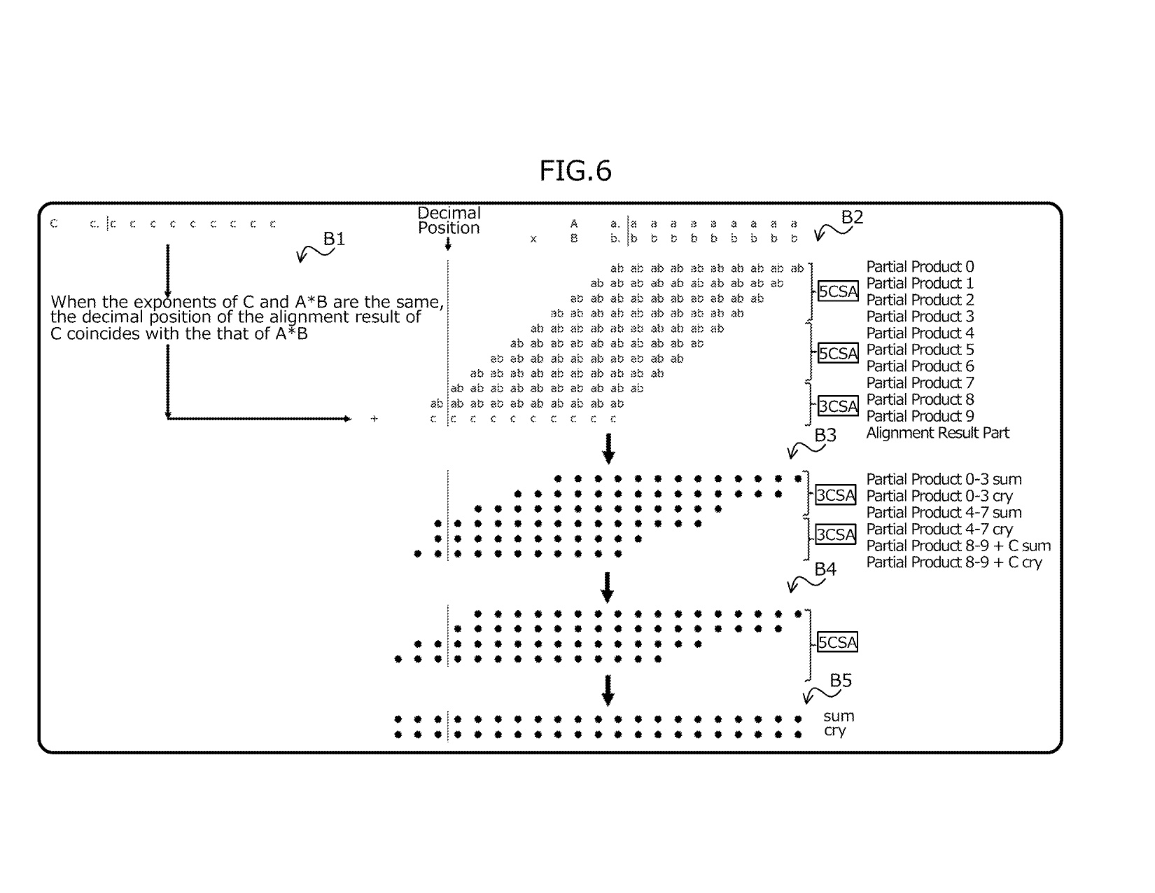

FIG. 6 is a diagram illustrating a calculation example in the CSA TREE 12c and the COMPRESSOR 12d illustrated in FIG. 4.

In the example illustrated in FIG. 6, a typical CSA calculation example is illustrated for the case where each significand part is 10 bits, and the exponents of C and A*B are the same.

As indicated by the symbol B1, when the exponents of C and A*B are the same, the decimal position of the alignment result of C coincides with the that of A*B.

In the symbol B2, the partial products 0 to 9 and the alignment result parts are calculated in two 5-input CSAs and one 3-input CSA.

In the symbol B3, the sum of the partial products 0 to 3, the cry of the partial products 0 to 3, the sum of the partial products 4 to 7, the cry of the partial products 4 to 7, the + c sum of the partial products 8 to 9, and the + c cry of the partial products 8 to 9 are calculated in two 3-input CSAs.

In the symbol B4, the calculation is performed in one 5-input CSA.

Then, in the symbol B5, an output equivalent to the sum and cry output by the COMPRESSOR 12d is made.

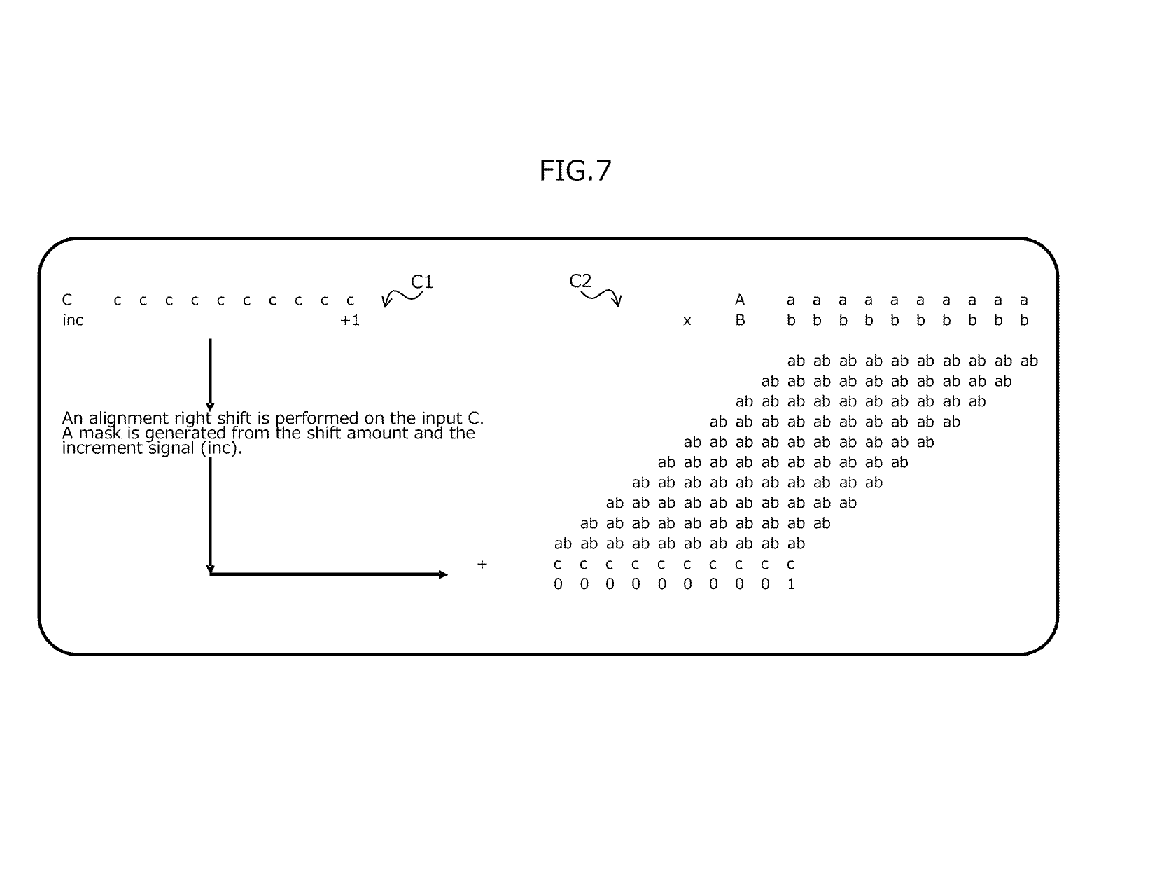

FIG. 7 is a diagram illustrating the addition processing performed by the CSA TREE 12c and the COMPRESSOR 12d illustrated in FIG. 4.

In the example illustrated in FIG. 7, in the symbol C1, the value C that has been bypassed and the signal inc indicating to increment it by +1 are illustrated. In the symbol C2, at the bottom row, the signal inc and a mask to which the shift amount is taken into consideration are added. When a right shift for alignment is performed on the input C in the symbol C1, a mask illustrated in the symbol C2 is generated from the shift amount at that time and the increment signal (inc).

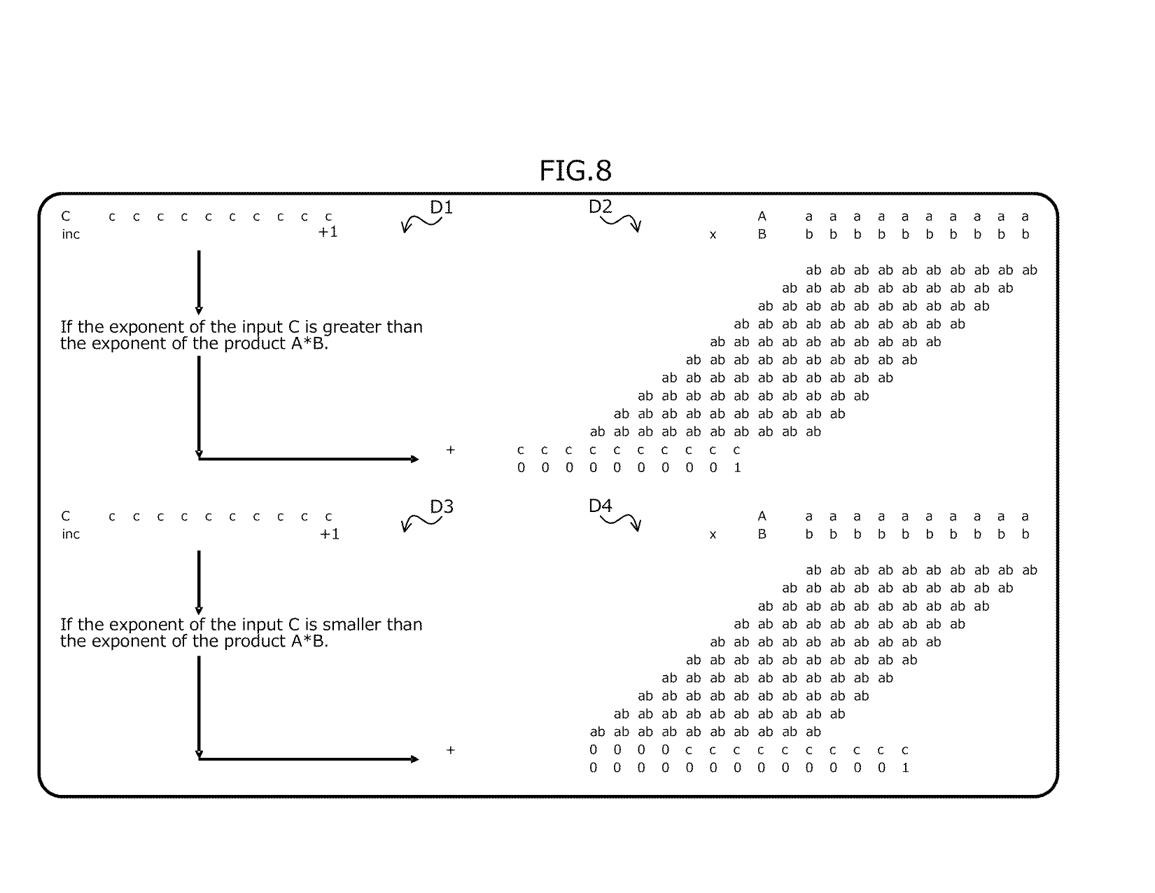

FIG. 8 is a diagram illustrating the change of the alignment shift amount.

In the symbol D1, the value C that has been bypassed and the signal inc indicating to increment it by +1 are illustrated. In the symbol D2, at the bottom row, the signal inc and a mask to which the shift amount is taken into consideration are added. If the exponent part of the input C in the symbol D1 is greater than the exponent of the result of the multiplication A*B, the mask illustrated in the symbol D2 is generated.

In the symbol D3, the value C that has been bypassed and the signal inc indicating to increment it by +1 are illustrated. In the symbol D3, at the bottom row, the signal inc and a mask to which the shift amount is taken into consideration are added. If the exponent part of the input C in the symbol D3 is smaller than the exponent of the result of the multiplication A*B, the mask illustrated in the symbol D4 is generated.

The complex case where the result of the multiplication and the correction position for incrementing by +1 overlap has been described. However, when the exponent of the input C is sufficiently larger than the exponent of the result of the multiplication A*B, only the result of the INCREMENTER 13b is selected. In that case, an increment by +1 by the signal inc may also be performed using the function by incrementing by +1 possessed by the INCREMENTER 13b.

### (B-2) Example of Operation

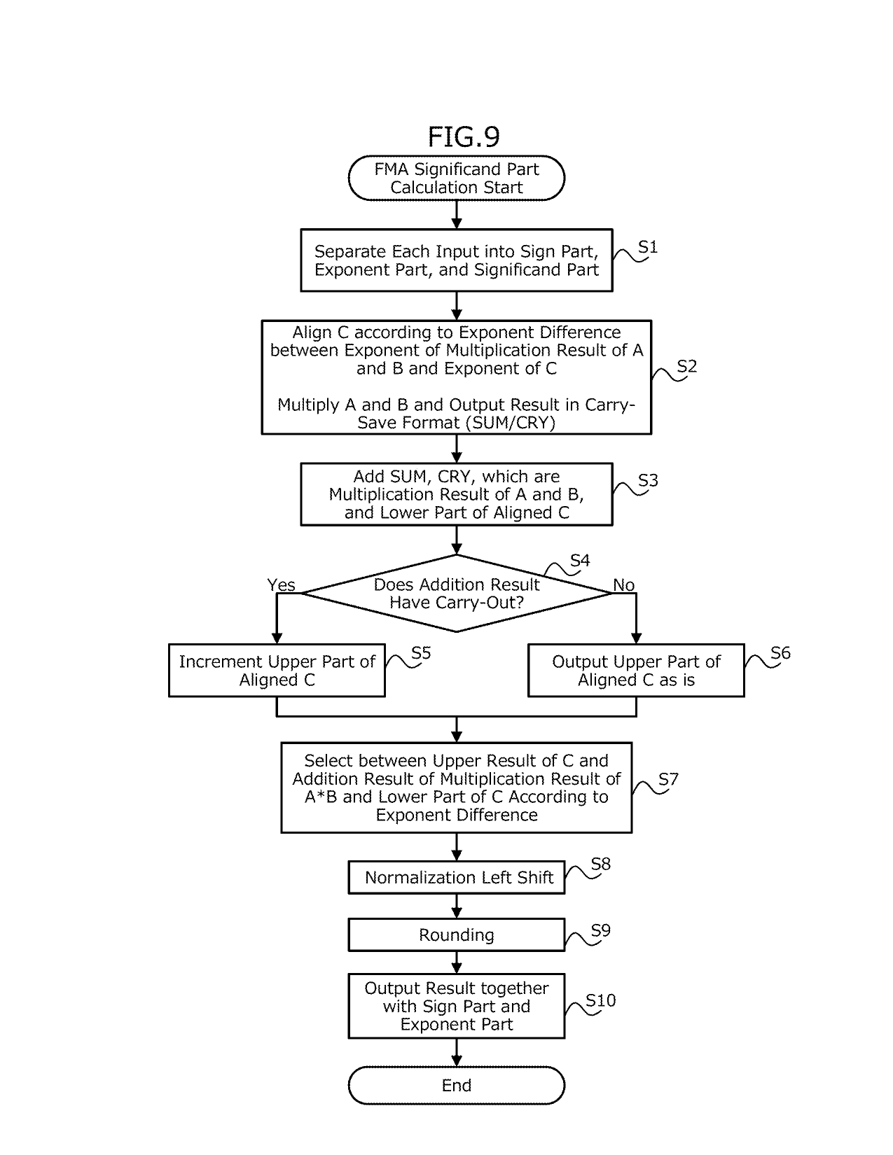

The FMA operation processing in the embodiment will be described with reference to the flowchart illustrated in FIG. 9 (Steps S1 to S10).

The FORMATs 11a to 11c separate each input data A, B, and C into a sign part, an exponent part, and a significand part (Step S1).

The RSFT 12b performs an alignment of C according to the exponent difference between the exponent of the result of the multiplication of A and B and the exponent of C, and the CSA TREE 12c multiplies A and B and outputs the result in the carry-save format (SUM/CRY) (Step S2).

The COMPRESSOR 12d adds the SUM and CRY, which are the result of the multiplications of A and B, and the lower part of the aligned C (Step S3).

The INCREMENTER 13b determines whether or not the addition result from the ADDER 13c has a carry-out (Step S4).

If the addition result has a carry-out (see the Yes route of Step S4), the INCREMENTER 13b increments the upper part of the aligned C by +1 (Step S5). The processing then proceeds to Step S7.

If the addition result has no carry-out (see the No route of Step S4), the INCREMENTER 13b outputs the upper part of the aligned C as is (Step S6).

The LSFT 14d selects between the upper result of C and the addition result of the multiplication result of A and B and the lower part of C, according to the exponent difference (Step S7).

The LSFT 14d performs a normalization left shift on the selected result (Step S8).

The ROUND 14e performs rounding on the output of the LSFT 14d (Step S9).

The FORMAT 14f outputs the result in which the significand part is formatted into the standardized format together with the sign part and the exponent part (Step S10). Then, the FMA operation processing ends.

### (B-3) Example of Hardware Configuration

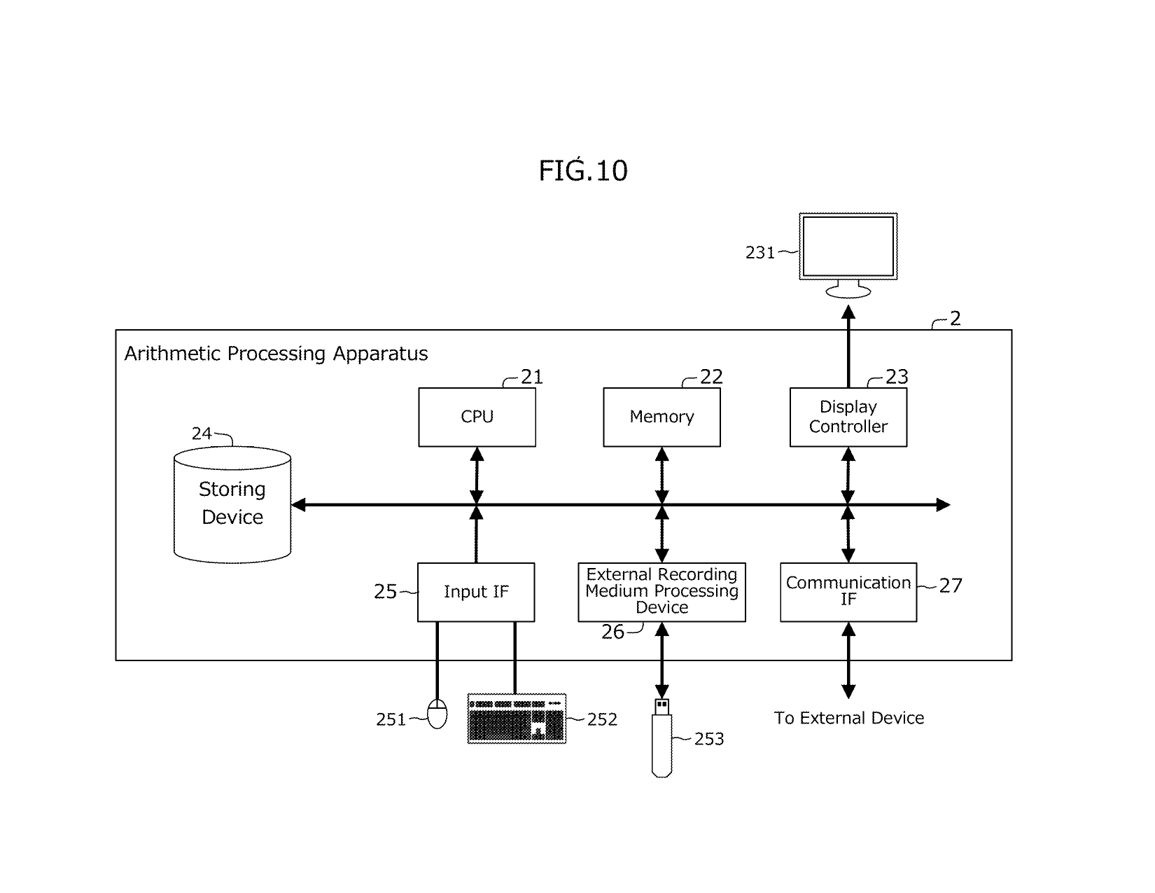

FIG. 10 is a block diagram schematically illustrating an example of the hardware configuration of the arithmetic processing apparatus 2 that executes the FMA arithmetic unit 100 in the embodiment.

As illustrated in FIG. 10, the arithmetic processing apparatus 2 includes a CPU 21, a memory 22, a display controller 23, a storing device 24, an input interface (IF) 25, an external recording medium processing device 26, and a communication IF 27.

The memory 22 is one example of a storage unit and may include, as an example, a Read Only Memory (ROM) and a RAM. Programs such as a Basic Input/Output System (BIOS) may be written in the ROM of the memory 22. Software programs in the memory 22 may be loaded into and executed by the CPU 21 as appropriate. In addition, the RAM of the memory 22 may be used as a temporary storage memory or a working memory.

The display controller 23 is connected to a display device 231 and controls the display device 231. The display device 231 may be a liquid crystal display, an Organic Light-Emitting Diode (OLED) display, a Cathode Ray Tube (CRT), an electronic paper display, or the like, and displays various information to the operator or other uses of the arithmetic processing apparatus 2. The display device 231 may be integrated with an input device, and may be, for example, a touch panel.

As the storing device 24, a Solid State Drive (SSD), a Storage Class Memory (SCM), or a Hard Disk Drive (HDD) may be used.

The input IF 25 is connected to input devices such as a mouse 251 and a keyboard 252, and may control the input devices such as the mouse 251 and the keyboard 252. The mouse 251 and the keyboard 252 are examples of input devices, and various input operations may be performed by the operator of the arithmetic processing apparatus 2 through these input devices.

The external recording medium processing device 26 is configured to allow the mounting of a recording medium 260. The external recording medium processing device 26 is configured to allow reading of information recorded on the recording medium 260 while the recording medium 260 is mounted. In this example, the recording medium 260 is portable. For example, the recording medium 260 may be a non-temporary recording medium such as a flexible disk, an optical disk, a magnetic disk, a magneto-optical disk, or a semiconductor memory.

The communication IF 27 is an interface for enabling communication with an external device.

The CPU 21 is one example of a processor and is a processing device that performs various controls and arithmetic operations. The CPU 21 functions as the FMA arithmetic unit 100 illustrated in FIG. 4. The CPU 21 embodies various functions by executing an OS or programs loaded into the memory 22. It should be noted that the CPU 21 may be a multiprocessor including a plurality of CPUs or a multicore processor having a plurality of CPU cores, or is configured to have a plurality of multicore processors.

The device that controls the operation of the entire arithmetic processing apparatus 2 is not limited to the CPU 21 and may be any one of an MPU, a DSP, an ASIC, a PLD, and an FPGA. Alternatively, the device that controls the operation of the entire arithmetic processing apparatus 2 may be a combination of two or more of a CPU, an MPU, a DSP, an ASIC, a PLD, and an FPGA. It should be noted that MPU is an abbreviation for Micro Processing Unit, DSP is an abbreviation for Digital Signal Processor, and ASIC is an abbreviation for Application Specific Integrated Circuit. In addition, PLD is an abbreviation for Programmable Logic Device, and FPGA is an abbreviation for Field Programmable Gate Array.

### (B-4) Modifications

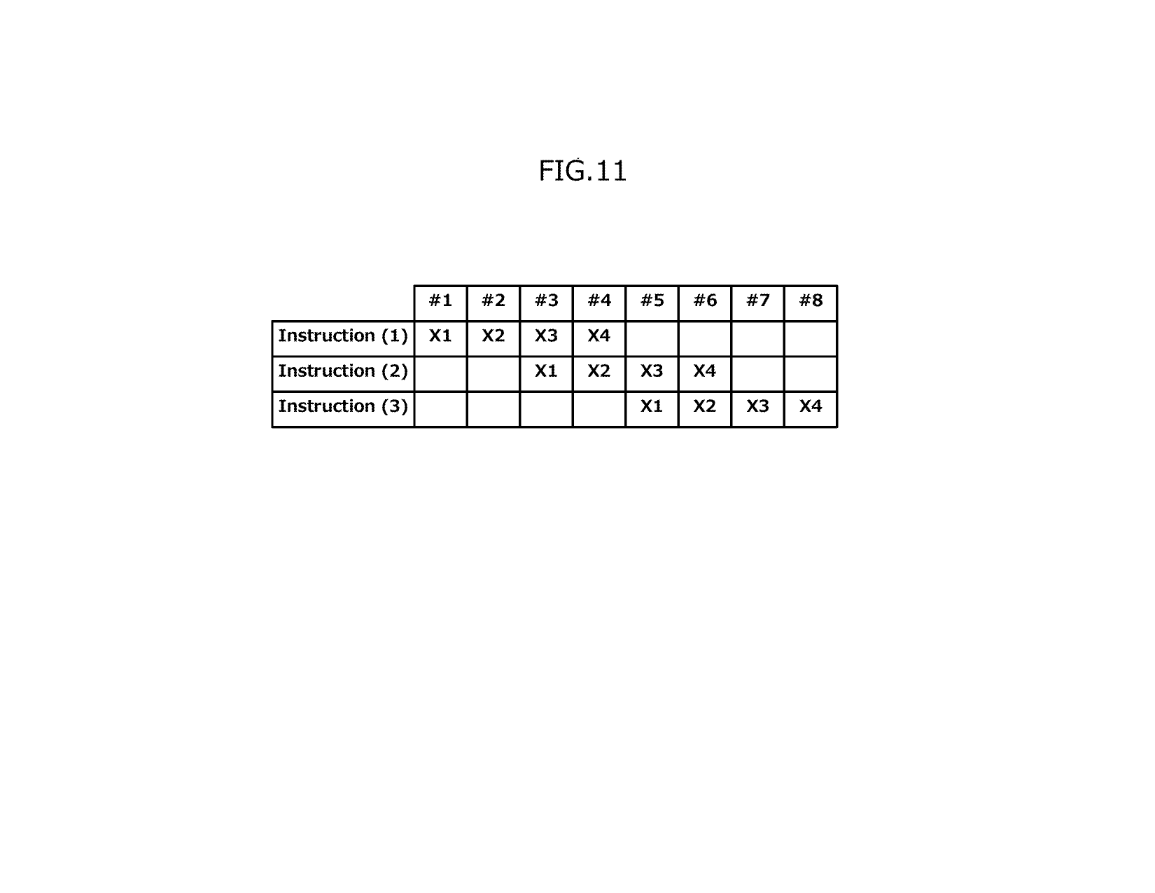

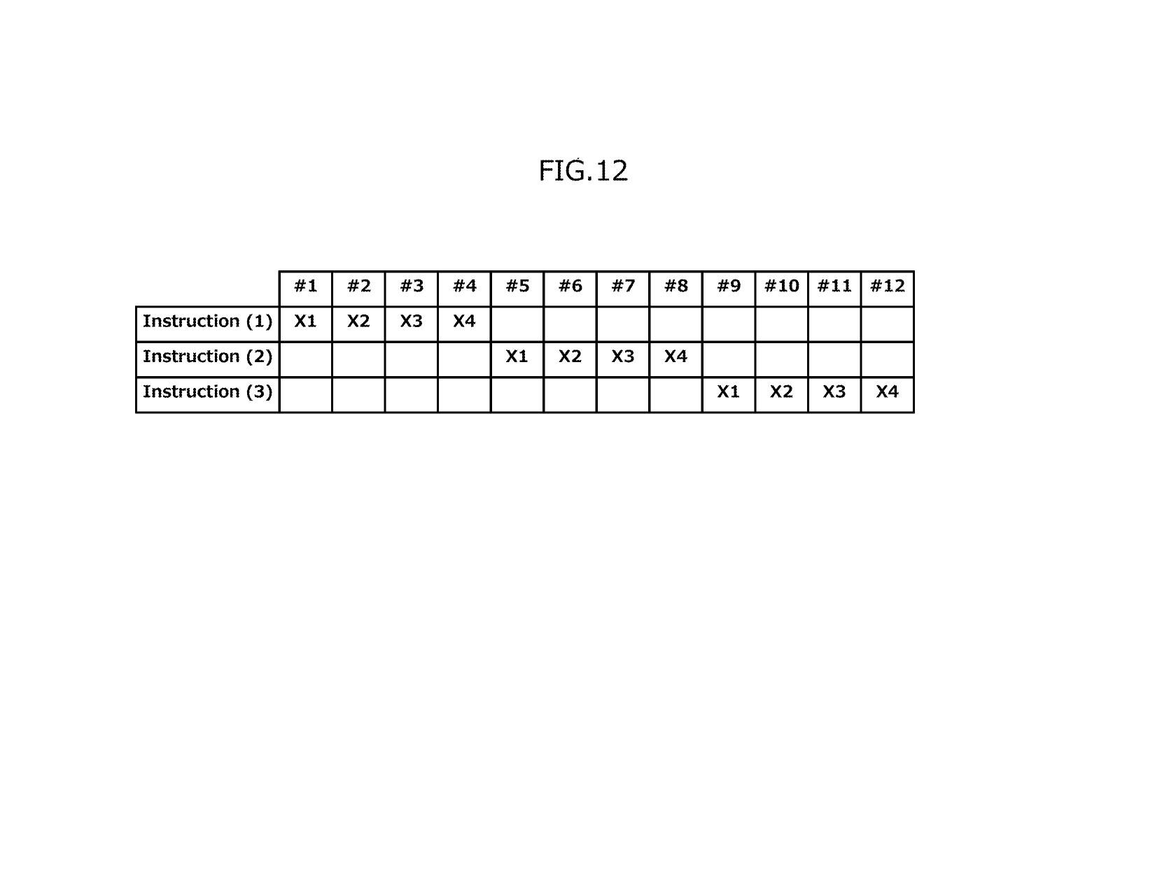

FIG. 11 is a table exemplifying instruction execution cycles in a case where the processing from inputs A and B completes in four cycles and the processing from input C completes in two cycles. FIG. 12 is a table exemplifying instruction execution cycles in a case where the latencies of all inputs are four cycles.

A method of changing the latencies of the inputs A and B and the latency of the input C in an FMA arithmetic unit is disclosed in U.S. Patent Application Publication No. 2011/0072066. This method can be applied to the FMA arithmetic unit 100 in the embodiment.

As illustrated in FIG. 11, in each of FMA instructions (1) to (3) that have consecutive data dependencies, processing of the cycles X1 to X4 is executed. The processing of the cycles X1 to X4 for the instruction (1) is executed at time #1 to #4; the processing of the cycles X1 to X4 for the instruction (2) is executed at time #3 to #6; and the processing of the cycles X1 to X4 for the instruction (3) is executed at time #5 to #8.

In the case where the latencies of all inputs are assumed to be four cycles as illustrated in FIG. 12, it takes 12 cycles to complete three instructions, whereas the computation is completed in 8 cycles in the example illustrated in FIG. 11.

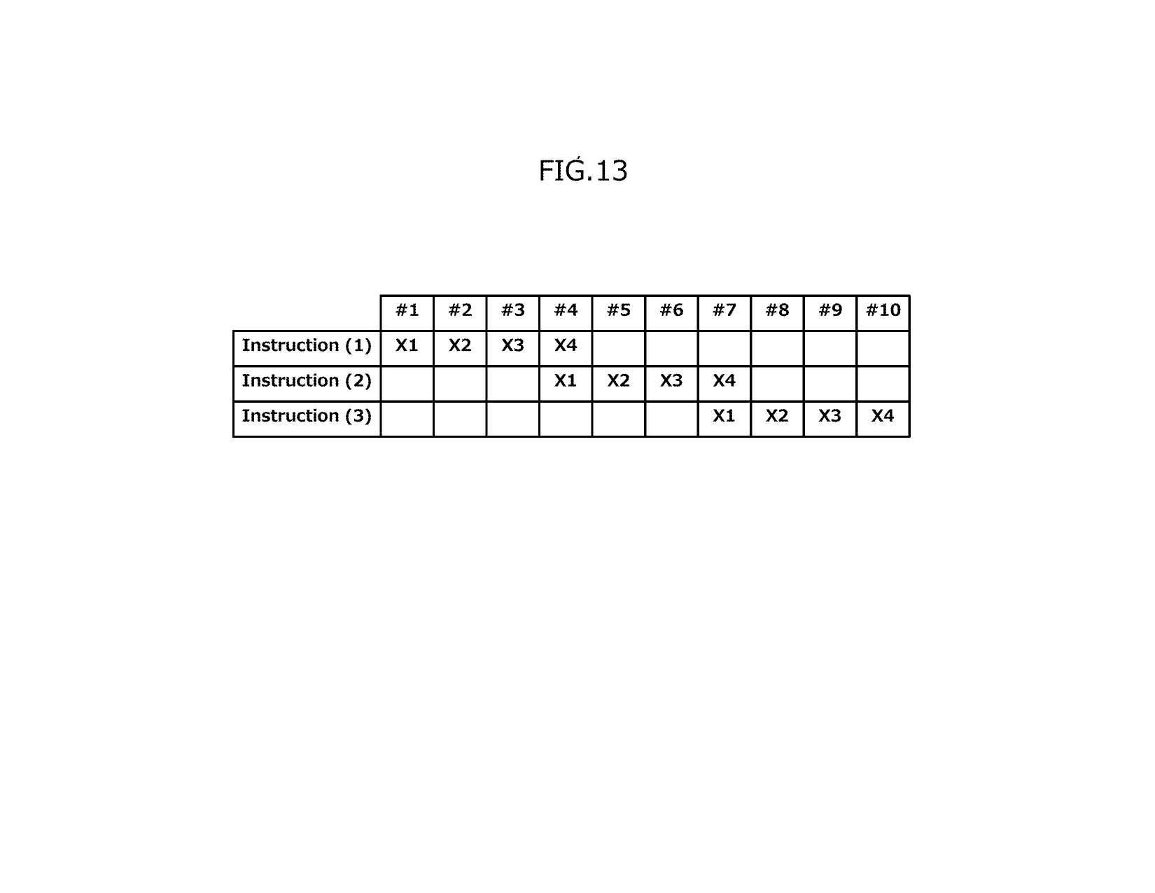

FIG. 13 is a table exemplifying instruction execution cycles in a case where only the bypass of an FMA operation is performed one cycle earlier.

The method of performing only the bypass of an FMA operation one cycle earlier is disclosed in B. Curran, B. McCredie, L. Sigal, E. Schwarz, B. Fleischer, Y.-H. Chan, D. Webber, M. Vaden, and A. Goyal, “4GHz+ low-latency fixed-point and binary floating-point execution units for the power6 processor,” in ISSCC, 2006. This method can also be applied to the FMA arithmetic unit 100 in the embodiment.

As illustrated in FIG. 13, in each of FMA instructions (1) to (3) that have consecutive data dependencies, processing of the cycles X1 to X4 is executed. The processing of the cycles X1 to X4 for the instruction (1) is executed at time #1 to #4; the processing of the cycles X1 to X4 for the instruction (2) is executed at time #4 to #7; and the processing of the cycles X1 to X4 for the instruction (3) is executed at time #7 to #10.

In this manner, in the case where the FMA operations take four cycles and can be shortened to three cycles, they can be completed in 10 cycles.

It should be noted that the method of performing only the bypass of an FMA operation one cycle earlier is also disclosed in H. Q. Le et al., “IBM power6 microarchitecture,” IBM J. Res. Develop., vol. 51, no. 6, pp. 639-662, 2007.

### (C) Effects

According to the arithmetic processing apparatus, the processor, and the arithmetic method in the embodiment and the modifications, for example, the following operational effects can be achieved.

The FMA arithmetic unit 100 bypasses the value before the rounding and the signal indicating whether or not an increment has occurred in the rounding, and uses them as inputs to the FMA arithmetic unit 100. The FMA arithmetic unit 100 executes a second floating-point multiply-add operation instruction using the inputs to the FMA arithmetic unit 100 before the execution of the first floating-point multiply-add operation instruction is completed.

As a result, the subsequent floating-point multiply-add instruction can be started without waiting for the completion of the preceding floating-point multiply-add instruction. Accordingly, it is possible to execute a plurality of data-dependent FMA operations at a high speed.

When executing the first floating-point multiply-add operation instruction expressed as A*B+C, the FMA arithmetic unit 100 aligns C according to the exponent difference between the exponent of the result of the multiplication of A and B and the exponent of C, and multiplies A and B to output the result in the carry-save format. The FMA arithmetic unit 100 adds the values represented in the carry-save format and the lower part of the aligned C. The FMA arithmetic unit 100 normalizes the upper part of the aligned C, which is either the incremented value or the result of the addition operation, according to the exponent difference, and uses it as the value before the rounding and as an input to the FMA arithmetic unit 100.

As a result, it is possible to speed up the bypass to input C without affecting the arithmetic operation from the inputs A and B as much as possible.

The FMA arithmetic unit 100 increments the upper part of the aligned C when a carry-out has occurred in the result of the addition.

As a result, it is possible to speed up the bypass to the input C when a carry-out has occurred, without affecting the arithmetic operation from the inputs A and B as much as possible.

When executing the second floating-point multiply-add operation instruction, the FMA arithmetic unit 100 inputs a signal indicating whether or not an increment has occurred in the rounding, as a mask, to the carry-save adder.

As a result, it is possible to know whether or not an increment has occurred in the skipped rounding.

### (D) Others

The disclosed technique is not limited to the above-described embodiment, and various modifications may be embodied without departing from the spirit of the present embodiment. Each element and each processing of the present embodiment may be selected as needed or may be combined as appropriate.

In one aspect, the subsequent floating-point multiply-add instruction can be started without waiting for the completion of the preceding floating-point multiply-add instruction.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An arithmetic processing apparatus comprising:
a memory configured to store a first floating-point multiply-add operation instruction and a second floating-point multiply-add operation instruction, the first floating-point multiply-add operation instruction and the second floating-point multiply-add operation instruction being data-dependent; and
a processor configured to execute the first floating-point multiply-add operation instruction and the second floating-point multiply-add operation instruction which are read from the memory,
the processor being configured to:
bypass a value before rounding and a signal indicating whether or not an increment has occurred in the rounding, to be input to the processor; and
execute the second floating-point multiply-add operation instruction using the input to the processor before an execution of the first floating-point multiply-add operation instruction is completed.

2. The arithmetic processing apparatus according to claim 1,
wherein the processor is configured to, when executing the first floating-point multiply-add operation instruction expressed as A*B+C:
align C according to an exponent difference between an exponent of a multiplication result of A and B and an exponent of C;
multiply A and B and output a result in a carry-save format;
add the value represented in the carry-save format and a lower part of the aligned C; and
normalize either a value obtained by incrementing an upper part of the aligned C according to the exponent difference or an value obtained by the addition operation, to be input to the processor as a value before the rounding.

3. The arithmetic processing apparatus according to claim 2,
wherein the processor is configured to
increment the upper part of the aligned C when a carry-out has occurs in a result of the addition.

4. The arithmetic processing apparatus according to claim 2,
wherein the processor is configured to
input a signal indicating whether or not an increment has occurred in the rounding as a mask, to a carry-save adder, when executing the second floating-point multiply-add operation instruction.

5. The arithmetic processing apparatus according to claim 3,
wherein the processor is configured to
input a signal indicating whether or not an increment has occurred in the rounding as a mask, to a carry-save adder, when executing the second floating-point multiply-add operation instruction.

6. A processor configured to execute a first floating-point multiply-add operation instruction and a second floating-point multiply-add operation instruction, the first floating-point multiply-add operation instruction and the second floating-point multiply-add operation instruction being data-dependent, the processor comprising a processing unit configured to:
bypass a value before rounding and a signal indicating whether or not an increment has occurred in the rounding, to be input to the processor; and
execute the second floating-point multiply-add operation instruction using the input to the processor before an execution of the first floating-point multiply-add operation instruction is completed.

7. The processor, according to claim 6, configured to, when executing the first floating-point multiply-add operation instruction expressed as A*B+C:
align C according to an exponent difference between an exponent of a multiplication result of A and B and an exponent of C;
multiply A and B and output a result in a carry-save format;
add the value represented in the carry-save format and a lower part of the aligned C; and
normalize either a value obtained by incrementing an upper part of the aligned C according to the exponent difference or an value obtained by the addition operation, to be input to the processor as a value before the rounding.

8. The processor, according to claim 7, configured to
increment the upper part of the aligned C when a carry-out has occurs in a result of the addition.

9. The processor, according to claim 7, configured to
input a signal indicating whether or not an increment has occurred in the rounding as a mask, to a carry-save adder, when executing the second floating-point multiply-add operation instruction.

10. The processor, according to claim 8, configured to
input a signal indicating whether or not an increment has occurred in the rounding as a mask, to a carry-save adder, when executing the second floating-point multiply-add operation instruction.

11. A computer-implemented arithmetic method for performing processing, by a computer configured to execute a first floating-point multiply-add operation instruction and a second floating-point multiply-add operation instruction, the first floating-point multiply-add operation instruction and the second floating-point multiply-add operation instruction being data-dependent, the arithmetic method comprising:
bypassing a value before rounding and a signal indicating whether or not an increment has occurred in the rounding, to be input to the computer; and
executing the second floating-point multiply-add operation instruction using the input to the computer before an execution of the first floating-point multiply-add operation instruction is completed.

12. The computer-implemented arithmetic method, according to claim 11, configured to, when executing the first floating-point multiply-add operation instruction expressed as A*B+C:
align C according to an exponent difference between an exponent of a multiplication result of A and B and an exponent of C;
multiply A and B and output a result in a carry-save format;
add the value represented in the carry-save format and a lower part of the aligned C; and
normalize either a value obtained by incrementing an upper part of the aligned C according to the exponent difference or an value obtained by the addition operation, to be input to the processor as a value before the rounding.

13. The computer-implemented arithmetic method, according to claim 12, configured to
increment the upper part of the aligned C when a carry-out has occurs in a result of the addition.

14. The computer-implemented arithmetic method, according to claim 12, configured to
input a signal indicating whether or not an increment has occurred in the rounding as a mask, to a carry-save adder, when executing the second floating-point multiply-add operation instruction.

15. The computer-implemented arithmetic method, according to claim 13, configured to
input a signal indicating whether or not an increment has occurred in the rounding as a mask, to a carry-save adder, when executing the second floating-point multiply-add operation instruction.
